(19) United States
(12) Patent Application Publication
(10) Pub. No.: US 2019/0001533 A1
(43) Pub. Date: Jan. 3, 2019

(54) COLLAPSIBLE TOOL STRUCTURE FOR SMALL FORM IMPLEMENTATION

(71) Applicant: Microsoft Technology Licensing, LLC, Redmond, WA (US)

(72) Inventors: Luke Michael MURPHY, North Bend, WA (US); Gabriel Joseph PIRIE, Seattle, WA (US); James LIAO, Nanshan, Shenzhen (CN)

(21) Appl. No.: 15/638,623

(22) Filed: Jun. 30, 2017

(51) Int. Cl. B29C 33/42; B29C 33/00; B29C 33/38; B29C 33/48

(52) U.S. Cl. CPC B29C 33/42; B29C 33/0088; B29C 33/485; B29C 33/38; B29C 33/005

(57) ABSTRACT

An embodiment of a device is described. The device may include a body. The body includes an outer surface and an inner surface defining a bore within the body. The inner surface defines a maximum inner dimension of the bore no more than 10 millimeters. The bore has a longitudinal axis therethrough. The device may include a plurality of parting lines on the inner surface of the body. The device may include a recess in the inner surface of the body. The recess may be a housed recess and may have a depth in a lateral direction perpendicular to the longitudinal axis of the bore.

### CROSS-REFERENCE TO RELATED APPLICATIONS

N/A

### BACKGROUND OF THE DISCLOSURE

Injection molding is conventionally performed by injecting material into a mold. The material flows into the mold and fills the volume in the mold, shaping the material to a final or near-final geometry. Injection molding is performed by introducing a fluid material into a volume within the mold, allowing the material to cool, cure, or harden, and removing the newly formed part from the mold.

The mold and/or part are conventionally designed to allow ease of removal from the mold. However, the necessity to separate the mold and part while maintaining the integrity of both the mold and the part can limit the geometries possible with injection molding. For example, some geometries may preclude release from the mold. Conventionally, such geometries may be cast by using a sacrificial mold or portion of the mold, increasing costs and reducing efficiency.

### SUMMARY

In some embodiments, a device includes a body. The body includes an outer surface and an inner surface defining a bore within the body. The inner surface defines a maximum inner dimension of the bore no more than 10 millimeters. The bore has a longitudinal axis therethrough. The device includes a plurality of parting lines on the inner surface of the body. The device includes a recess in the inner surface of the body. The recess may be a housed recess and may have a depth in a lateral direction perpendicular to the longitudinal axis of the bore.

In some embodiments, an electronic device may include a body. The body includes an outer surface and an inner surface defining a bore within the body. The inner surface defines a maximum inner dimension of the bore no more than 10 millimeters. The bore has a longitudinal axis therethrough. The device includes a recess in the inner surface of the body and has a depth in a lateral direction perpendicular to the longitudinal axis of the bore. The depth is at least 1% of the maximum inner dimension. The device includes an electronic component positioned at least partially in the recess.

In some embodiments, a method of manufacturing a device includes providing a mold having a mandrel including a first core insert with a protrusion in a lateral direction and a second core insert. The mold defines a volume where the mandrel defines an inner surface of the volume with an inner diameter no more than 10 millimeters. A fluid is injected into the volume to form a body having a recess in an inner surface of a bore. The recess corresponds to the protrusion. The body is released from the mold. Releasing the body includes moving the second core insert in a longitudinal direction relative the first core insert and body and moving the body in the lateral direction relative to the first core insert and in a protrusion direction to disengage the body from the protrusion.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a perspective view of an embodiment of a body, according to at least one embodiment of the present disclosure;

FIG. 2 is a side cross-sectional view of the embodiment of a body of FIG. 1, according to at least one embodiment of the present disclosure;

FIG. 3A is a side cross-sectional view of an embodiment of a mold for forming a body, according to at least one embodiment of the present disclosure;

FIG. 3B is a perpendicular cross-sectional view of the embodiment of a mold for forming a body of FIG. 3A, according to at least one embodiment of the present disclosure;

FIG. 4 is a side cross-sectional view of the embodiment of a mold for forming a body of FIG. 3A showing a component of the mold moving, according to at least one embodiment of the present disclosure;

FIG. 5 is a side cross-sectional view of the embodiment of a mold for forming a body of FIG. 3A showing a plurality of components of the mold moving in a lateral direction, according to at least one embodiment of the present disclosure;

FIG. 6 is a side cross-sectional view of the embodiment of a mold for forming a body of FIG. 3A showing the mandrel of the mold moving, according to at least one embodiment of the present disclosure;

FIG. 7 is a side cross-sectional view of the embodiment of a mold for forming a body of FIG. 3A showing a second core insert moving relative to a first core insert, according to at least one embodiment of the present disclosure;

FIG. 8 is a side cross-sectional view of the embodiment of a mold for forming a body of FIG. 3A showing the body removed from the mold, according to at least one embodiment of the present disclosure;

FIG. 9 is a side cross-sectional view of another embodiment of a body, according to at least one embodiment of the present disclosure;

FIG. 10 is a side cross-sectional view of yet another embodiment of a body, according to at least one embodiment of the present disclosure;

FIG. 11 is a side cross-sectional view of another embodiment of a mold, according to at least one embodiment of the present disclosure;

FIG. 12 is a side partial cross-sectional view of an embodiment of an electronic device including a body, according to at least one embodiment of the present disclosure; and

FIG. 13 is a flowchart illustrating an embodiment of a method of manufacturing, according to at least one embodiment of the present disclosure.

### DETAILED DESCRIPTION

This disclosure generally relates to devices, systems, and methods for manufacturing small geometry devices by injection molding. More specifically, devices systems, and methods described herein may relate to injection molding of small geometry devices or pieces having a lateral recess in a bore positioned at least partially through the device. At least one device, system, or method herein may relate to injection molding of a body with a bore less than 10 millimeters (mm) in a maximum interior dimension and including a lateral housed recess in the inner surface of the bore.

In some embodiments, a device may include a body with a bore therein. The bore may extend from a first longitudinal end of the body toward a second longitudinal end of the body. The body may have an outer surface and an inner surface. The inner surface may define the bore. The device may have a thickness of the body between the inner surface and the outer surface. In some embodiments, it may be advantageous to have one or more areas of the body with a thickness less than the remainder of the body. For example, the body may have a recess in the inner surface such that a thickness of the body is less at the recess. This may allow for positioning of one or more components or devices inside the body and closer to the outer surface than the inner surface may otherwise allow. The recess may also allow for the mechanical locking of one or more components or devices within the bore in a rotational and/or longitudinal direction relative to the body.

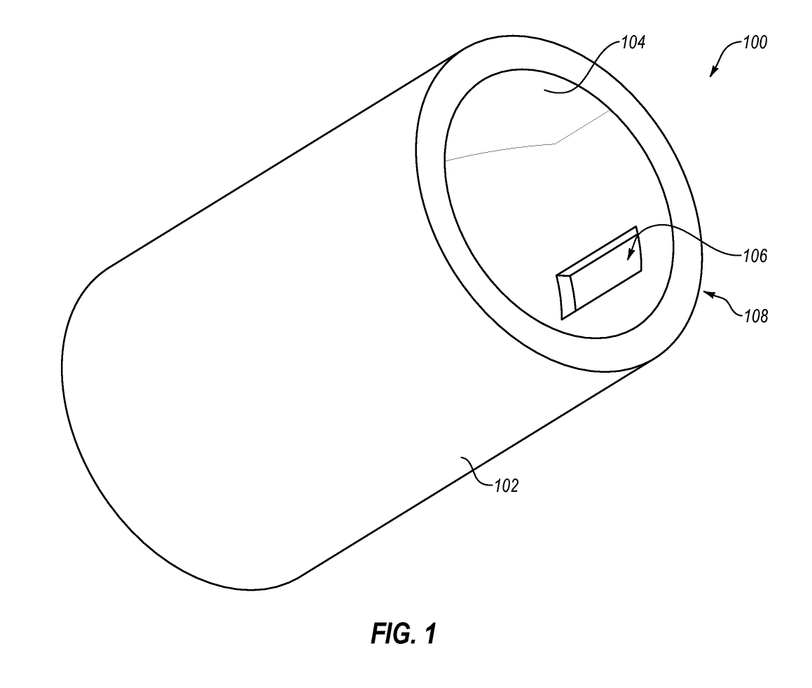

FIG. 1 is a perspective view of a body 100 formed by injection molding. In some embodiments, the body 100 has an outer surface 102 and an inner surface 104. The inner surface 104 of the body 100 may include a recess 106 that extends laterally from the inner surface 104. For example, the inner surface 104 may define a bore 108, and the recess 106 may extend away from the bore 108 and toward the outer surface 102.

In some embodiments, the recess 106 is a housed recess. For example, a housed recess may be bounded on five sides. In another example, a housed recess may be bounded on the left, right, top, bottom, and outer surface (e.g., open on the inner surface). In other words, a housed recess may include a partial sphere, a partial ovoid, other rounded three-dimensional shapes, a partial pentagon, a partial hexagon, or other partial three-dimensional polygonal shapes which include an opening on one side. The recess 106 shown in FIG. 1 is bounded by the body 100 on five sides while remaining open to the bore 108 adjacent the inner surface 104. In some embodiments, the bore 108 may continue through the entire body 100, while in other embodiments, the bore 108 may continue through a portion of the body 100 and may terminate at a closed end.

In some embodiments, the bore 108 may have a perpendicular cross-section that is circular. For example, the perpendicular cross-section of the inner surface 104 may be circular. In other embodiments, the bore 108 may have a perpendicular cross-section that is at least partially elliptical. In yet other embodiments, the bore 108 may have a perpendicular cross-section that is at least partially curved. For example, the bore 108 may have a perpendicular cross-section that is a rounded rectangle. In another example, the bore 108 may have a perpendicular cross-section that is an irregular curved shape. In further embodiments, the bore 108 may have a perpendicular cross-section that is polygonal. For example, the bore 108 may have a perpendicular cross-section that is triangular, square, rectangular, pentagonal, hexagonal, octagonal, or otherwise polygonally shaped. In some examples, the bore 108 may have a perpendicular cross-section that is a regular polygon, while in other examples, the bore 108 may have a perpendicular cross-section that is an irregular polygon.

In some embodiments, the body 100 may have a thickness between the inner surface 104 and outer surface 102 that is constant in a longitudinal direction, a lateral direction, a rotational direction, or any combinations thereof. For example, the outer surface 102 may have a perpendicular cross-section that is the same shape as perpendicular cross-section of the inner surface 104 proportionately larger. In other embodiments, the body 100 may have a thickness between the inner surface 104 and outer surface 102 that varies in a longitudinal direction, a lateral direction, a rotational direction, or any combinations thereof.

In some embodiments, the outer surface 102 may have a perpendicular cross-section that is circular. In other embodiments, the outer surface 102 may have a perpendicular cross-section that is at least partially elliptical. In yet other embodiments, the outer surface 102 may have a perpendicular cross-section that is at least partially curved. For example, the outer surface 102 may have a perpendicular cross-section that is a rounded rectangle. In another example, the outer surface 102 may have a perpendicular cross-section that is an irregular curved shape. In further embodiments, the outer surface 102 may have a perpendicular cross-section that is polygonal. For example, the outer surface 102 may have a perpendicular cross-section that is triangular, square, rectangular, pentagonal, hexagonal, octagonal, or other polygonal. In some examples, the outer surface 102 may have a perpendicular cross-section that is a regular polygon, while in other examples, the outer surface 102 may have a perpendicular cross-section that is an irregular polygon.

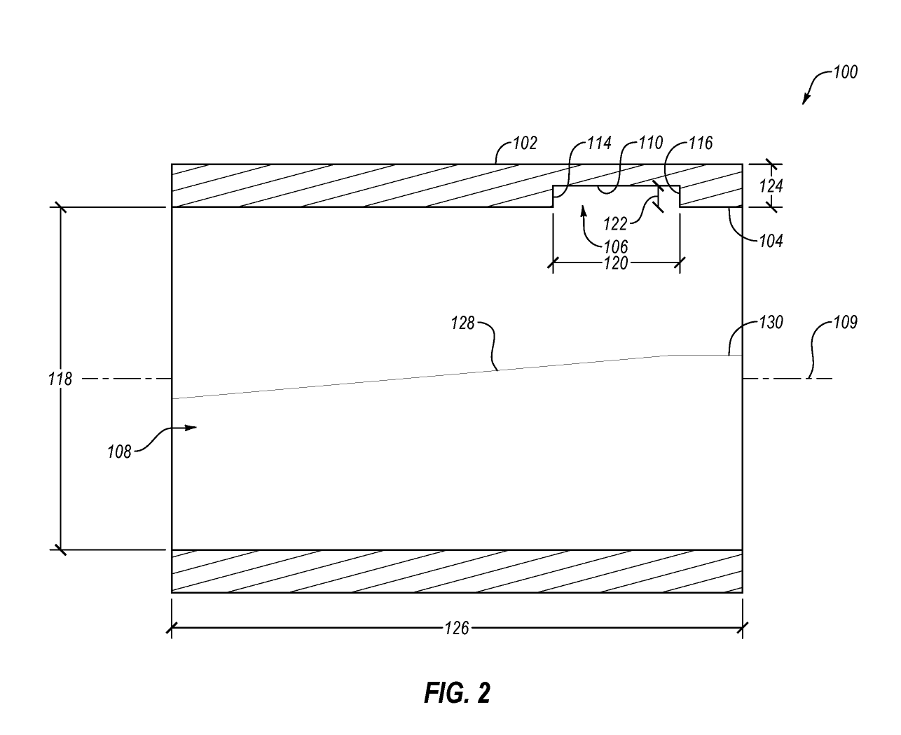

FIG. 2 is a side cross-sectional view of the embodiment of a body 100 of FIG. 1. The bore 108 of the body 100 may have a longitudinal axis 109 through the bore 108. In some embodiments, the longitudinal axis 109 of the bore 108 may be the longitudinal axis of the body 100. For example, the body 100 and bore 108 are concentric in the embodiment illustrated in FIG. 1 and FIG. 2 with a shared longitudinal axis. In other embodiments, the longitudinal axis 109 of the bore 108 may be at an angle to a longitudinal axis of the body 100. For example, the bore 108 may be oriented perpendicular to an elongated body.

In some embodiments, the recess 106 may be located in the inner surface 104 and may extend from the inner surface 104 to a bottom face 110 of the recess 106. The bottom face 110 may be the face of the recess 106 radially furthest from the longitudinal axis 109. In some embodiments, the recess 106 may have a lower face 114 and an upper face 116 that extend from the inner surface 104 to the bottom face 110 of the recess 106. In some embodiments, the lower face 114 and the upper face 116 may define the lower and upper longitudinal ends of the recess 106.

In some embodiments, a recess length 120 of the recess 106 may be the maximum distance in the longitudinal direction (i.e., in the direction of the longitudinal axis 109) from a point where the lower face 114 meets the inner surface 104 to a point where the upper face 116 meets the inner surface 104. In some embodiments, the recess length 120 may be related to a body length 126. For example, the recess length 120 may be at least 0.8 millimeters. In other examples, the recess length 120 may be less than the body length 126 such that the recess is housed on each longitudinal end by the body 100.

In some embodiments, an inner diameter 118 of the body 100 (e.g., a diameter of the bore 108) may at least partially constrain one or more dimensions of the body 100. For example, a body length 126 of the body 100 and/or a depth 122 of the recess 106 may be at least partially related to the inner diameter 118 of the body 100.

The inner diameter 118 of the body 100 may be smaller than achievable with conventional collapsible core injection molding. In some embodiments, the inner diameter 118 may be in a range having an upper value, a lower value, or upper and lower values including any of 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, and 10.0 mm. For example, the inner diameter 118 may be less than 10.0 mm. In other examples, the inner diameter 118 may be less than 9.0 mm. In yet other examples, the inner diameter 118 may be less than 8.0 mm. In further examples, the inner diameter 118 may be between 4.0 mm and 10.0 mm. In at least one embodiment, the inner diameter is between 7.0 mm and 9.0 mm.

In some embodiments, the body length 126 may be related to the inner diameter 118 by a bore ratio. In some embodiments, the bore ratio may include an upper value, a lower value, or upper and lower values including any of 0.5:1.0, 1.0:1.0, 1.5:1.0, 2.0:1.0, 2.5:1.0, 3.0:1.0, 3.5:1.0, or any values therebetween. For example, the bore ratio may be greater than 0.5:1.0. In other examples, the bore ratio may be less than 3.5:1.0. In yet other examples, the bore ratio may be between 0.5:1.0 and 3.5:1.0. In further examples, the bore ratio may be less than 3.0:1.0. In at least one example, the bore ratio is 3.5:1.0. In another example, the body length 126 is 19.5 mm and the inner diameter 118 is 6.0 mm. In yet another example, the body length 126 is 35 mm and the inner diameter is 10.0 mm.

In some embodiments, the depth 122 may be related to the inner diameter 118 by a depth ratio (i.e., depth 122 to inner diameter 118. For example, the depth 122 of the recess 106 may be related to the amount of clearance in the bore 108 through which a portion of a mold may be positioned. In some embodiments, the depth ratio may have an upper value, a lower value, or upper and lower values including any of 1:100, 1:50, 1:20, 1:10, 1:8, 1:6, 1:5, 1:4, 1:3, or any values therebetween. For example, the depth ratio may be greater than 1:100. In other examples, the depth ratio may be less than 1:3. In yet other examples, the depth ratio may be between 1:100 and 1:3. In further examples, the depth ratio may be between 1:50 and 1:4. In yet further examples, the depth ratio may be between 1:20 and 1:5.

In some embodiments, the depth 122 may be related to the thickness 124 of the body 100 between the inner surface 104 and the outer surface 102 by a thickness ratio (i.e., depth 122 to thickness 124). In some embodiments, the thickness ratio may have an upper value, a lower value, or upper and lower values including any of 1:100, 1:50, 1:20, 1:10, 1:8, 1:6, 1:5, 1:4, 1:3, 1:2, 1:1.5, 1:1.1, or any values therebetween. For example, the thickness ratio may be greater than 1:100. In other examples, the depth ratio may be less than 1:1.1. In yet other examples, the thickness ratio may be between 1:100 and 1:1.1. In further examples, the thickness ratio may be between 1:50 and 1:1.5. In yet further examples, the thickness ratio may be between 1:20 and 1:2.

In at least one embodiment, the bore ratio may be 3.0:1.0, the depth ratio may be between 1:20 and 1:5, and the thickness ratio may be between 1:20 and 1:2. In other embodiments, other combinations of bore ratio, depth ratio, and thickness ratio may be selected from any of the values provided herein. Any permutation is contemplated.

During the injection molding process, a seam between two or more portions of the mold may produce a parting line on the body 100. In some embodiments, at least a portion of the parting line may be an angled parting line 128 oriented at an angle to the longitudinal axis 109. In other embodiments, at least a portion of the parting line may be an axial parting line 130 parallel to the longitudinal axis 109.

In some embodiments, the angled parting line 128 may be oriented at an angle to the longitudinal axis 109 in a range having an upper value, a lower value, or upper and lower values including any of 5°, 10°, 15°, 20°, 25°, 30°, 35°, 40°, 45°, 50°, 55°, 60°, or any values therebetween. For example, at least a portion of the angled parting line 128 may be oriented at an angle greater than 5° relative to the longitudinal axis 109. In other examples, at least a portion of the angled parting line 128 may be oriented at an angle less than 60° relative to the longitudinal axis 109. In yet other examples, at least a portion of the angled parting line 128 may be oriented at an angle between 5° and 60° relative to the longitudinal axis 109. In further examples, at least a portion of the angled parting line 128 may be oriented at an angle between 10° and 55° relative to the longitudinal axis 109. In yet further examples, at least a portion of the angled parting line 128 may be oriented at an angle between 15° and 45° relative to the longitudinal axis 109. In at least one example, the angled parting line 128 is oriented at 15° relative to the longitudinal axis 109.

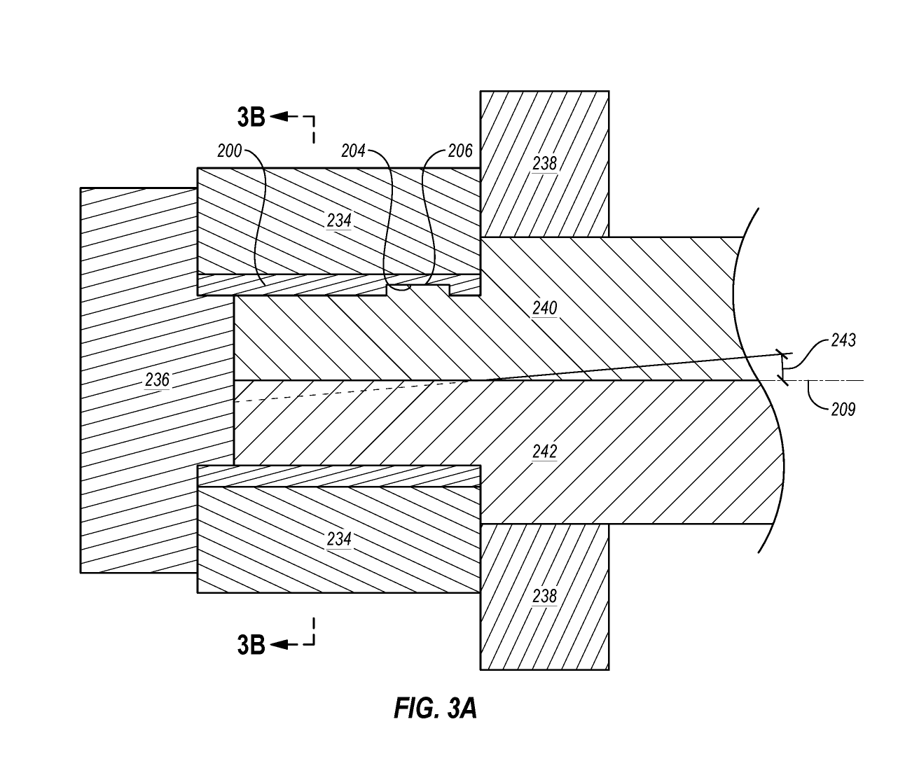

The embodiment of a body 100 described in relation to FIG. 1 and FIG. 2, as well as other embodiments, may be injection molded by one or more embodiments of a process described in relation to FIG. 3A through FIG. 8. FIG. 3A illustrates an embodiment of a mold having a plurality of components. The mold may provide a volume into which material is injected to form an embodiment of a body 200. The mold may include a plurality of components that movable relative to one another to allow the release of one or more portions of the body 200 after injection molding. The sliders 234 positioned radially about the body 200 may form at least part of the outer surface of the body 200, while the longitudinal length of the body 200 may be constrained by one or more of a cavity 236 and/or a core 238 of the mold. A core insert including a first core insert 240 and a second core insert 242 may provide a mandrel and protrusion 241 that define at least part of the inner surface of the body 200. The protrusion 241 may extend radially away from the longitudinal axis 209 and into the body 200 to form the recess 206.

The first core insert 240 and the second core insert 242 may be longitudinally movable relative to one another to allow the lateral displacement of the body 200 relative to the first core insert 240. For example, the first core inserts 240 and second core insert 242 may contact one another along a sloped interface. The contact of the first core insert 240 and the second core insert 242 may act as a wedge, urging the first core insert 240 and the second core insert 242 in a lateral direction. For example, longitudinal movement of the second core insert 242 toward the cavity 236 relative to the first core insert 240 may slide the second core insert 242 past the first core insert 240 along the sloped interface urging one or both the first core insert 240 and second core insert 242 toward the sliders 234. The sloped interface may be oriented at a wedge angle 243 relative to the longitudinal axis 209. The contact of the first core insert 240 and the second core insert 242 may create the angled and/or straight parting line on the body 200 (such as angled parting line 128 and straight parting line 130, described in relation to FIG. 2).

In some embodiments, the wedge angle 243 may be in a range having an upper value, a lower value, or upper and lower values including any of 5°, 10°, 15°, 20°, 25°, 30°, 35°, 40°, 45°, 50°, 55°, 60°, or any values therebetween. For example, the wedge angle 243 may be greater than 5°. In other examples, the wedge angle 243 may be less than 60°. In yet other examples, the wedge angle 243 may be between 5° and 60°. In further examples, the wedge angle 243 may be between 10° and 55°. In yet further examples, the wedge angle 243 may be between 15° and 45°. In at least one example, the wedge angle 243 may be 15°.

In some embodiments, the first core insert 240 and second core insert 242 may have one or more engagement features configured to limit and/or prevent movement of the first core insert 240 and second core insert 242 in a lateral direction relative to one another. FIG. 3B is a perpendicular cross-sectional view (e.g., perpendicular to the longitudinal axis 209 of FIG. 3A) of the mold components and body 200 of FIG. 3A. The embodiment of a body 200 shown in FIG. 3B is an annular structure, but may have other shapes. The body 200 may be injection molded in the volume between the sliders 234 and the mandrel formed by the first core insert 240 and second core insert 242.

FIG. 3B illustrates a plurality of sliders 234 defining the outer surface of the volume of the mold and/or the body 200. In some embodiments, the mold includes sliders 234 positioned at equal angular intervals. For example, FIG. 3B illustrates four sliders 234 positioned at equal 90° intervals about the body 200. In other embodiments, the mold includes sliders 234 positioned at unequal intervals. For example, a first slider may cover 180° of the body, while a second slider and a third slider each cover 90° of the remaining 180°, respectively. While FIG. 3B depicts four sliders 234 surrounding the body 200, in other embodiments, the mold may include 1, 2, 3, 5, 6, 7, 8, 9, 10, or more sliders 234 about the body 200.

In some embodiments, an engagement feature 245 positioned between the first core insert 240 and second core insert 242 may allow the first core insert 240 and second core insert 242 to move longitudinally relative to one another, while limiting and/or preventing movement in a lateral direction. For example, the engagement feature 245 may be a dovetail, such as shown in FIG. 3B. The dovetail may limit and/or prevent movement of the first core insert 240 in a horizontal direction in FIG. 3B relative to the second core insert 242 while also limiting movement in a vertical direction in FIG. 3B relative to the second core insert 242. In other embodiments, an engagement feature 245 may be or include a rail or protrusion that limits and/or prevents movement of the first core insert 240 in a horizontal direction in FIG. 3B relative to the second core insert 242 while not restricting movement in a vertical direction in FIG. 3B relative to the second core insert 242.

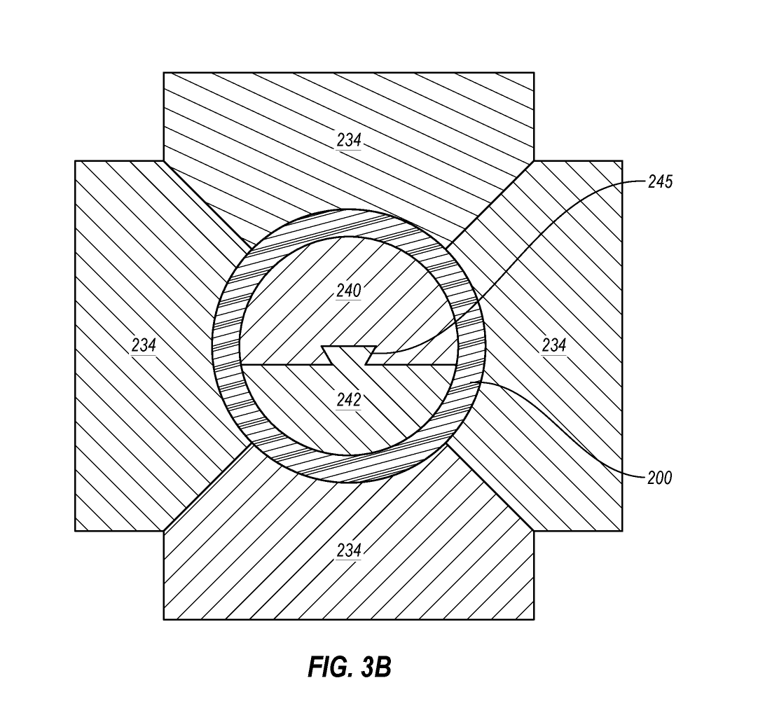

To release the body 200 from the mold, a plurality of the mold components may be moved in sequence. FIG. 4 is a side cross-sectional view of the mold of FIG. 3A after molding the body 200. The cavity 236 may be moved in a first longitudinal direction 244 away from the body 200, sliders 234, and core 238. The cavity 236 may cease to be in contact with the first core insert 240 and second core insert 242.

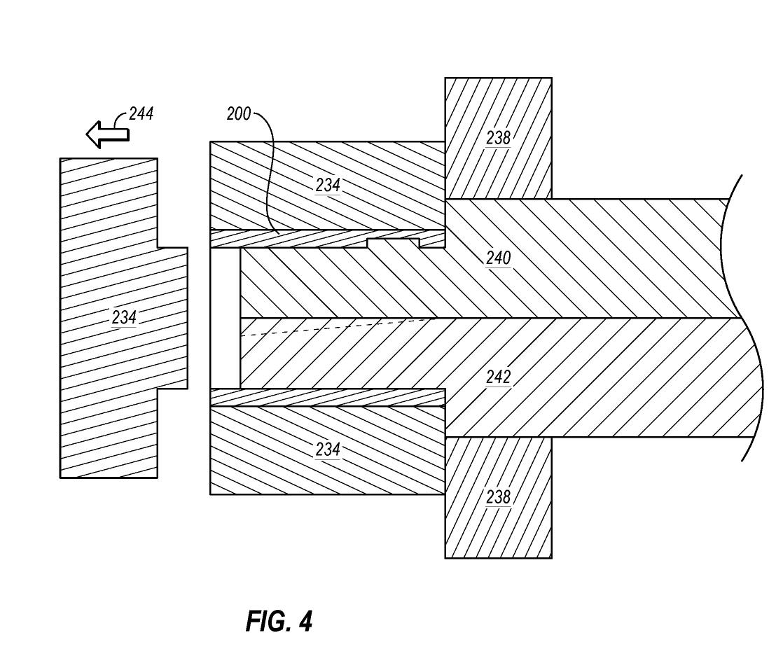

FIG. 5 illustrates the movement of the sliders 234 in a radial direction 246 away from the body 200 and/or the longitudinal axis 209 and relative to the core 238. The radial movement of the sliders 234 may release an outer surface of the body 200. The mandrel formed by the first core insert 240 and the second core insert 242 may limit and/or prevent lateral movement of the body 200. Additionally, the first core insert 240 may limit the longitudinal movement of the body 200.

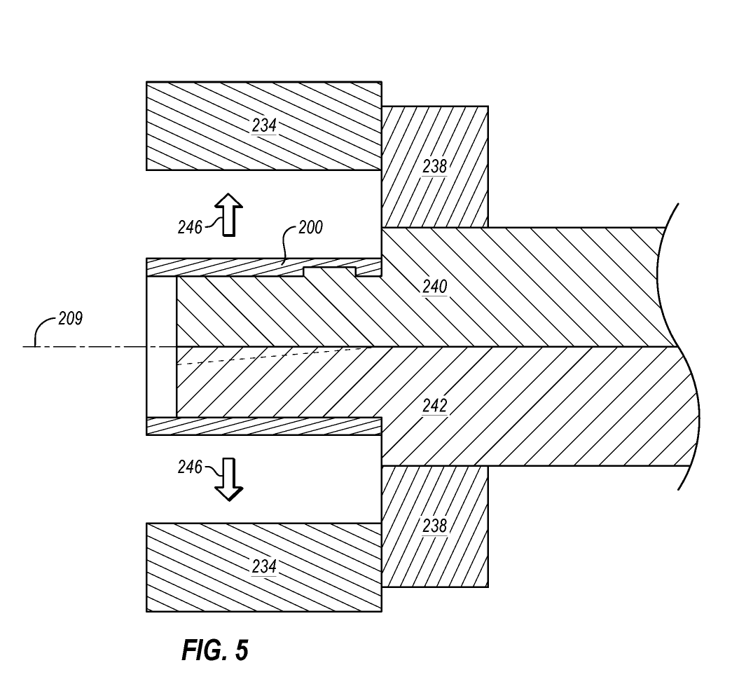

FIG. 6 illustrates a movement of the body 200 and mandrel (including the first core insert 240 and second core insert 242) in the first longitudinal direction 244 away from the core 238 to advance the body 200 longitudinally. In some embodiments, the body 200 may be advanced longitudinally beyond the sliders 234 (e.g., the body 200 and the sliders 234 do not overlap in the longitudinal direction) to provide clearance to move the body 200 in a lateral direction relative to the first core insert 240 and/or second core insert 242. In other embodiments, the body 200 may be advanced longitudinally such that at least a portion of the body 200 is longitudinally beyond the sliders 234 (i.e., not longitudinally overlapping the sliders 234) while at least a second portion of the body 200 longitudinally overlaps a portion of the sliders 234.

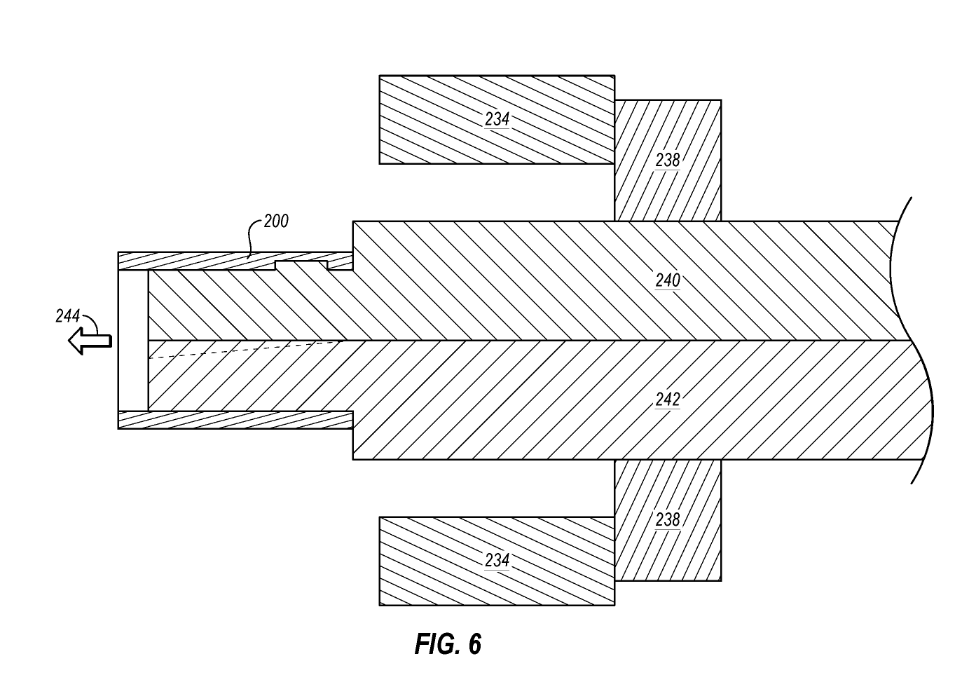

In some embodiments, upon moving the body 200 in a first longitudinal direction 244, at least a portion of the mandrel (e.g., the second core insert 242) may move in the opposite longitudinal direction 248, such as shown in FIG. 7, toward the core 238. FIG. 7 illustrates the second core insert 242 moving in a second longitudinal direction 248 relative to the first core insert 240 such that the second core insert 242 is longitudinally beyond the end of the body 200. For example, no portion of the second core insert 242 longitudinally overlaps any portion of the body 200. In other embodiments, at least a portion of the body 200 and a portion of the second core insert 242 may longitudinally overlap one another.

In some embodiments, the engagement features 245 of the first core insert 240 and second core insert 242 may disengage from one another, allowing movement in additional directions. In other embodiments, the engagement features 245 may remain in engagement, limiting the movement of the second core insert 242 and first core insert 240 to longitudinal movement relative to one another.

In other embodiments, the first core insert 240 may be advanced in a first longitudinal direction (such as first longitudinal direction 244 of FIG. 6) relative to the second core insert 242 and sliders 234 to provide clearance to move the body 200 in a transverse direction. For example, the first core insert 240 may be advanced in the first longitudinal direction 244 without the second core insert 242 being advanced in the first longitudinal direction 244. In another example, the first core insert 240 may be advanced in the first longitudinal direction 244 while the second core insert 242 is moved in the second longitudinal direction 248.

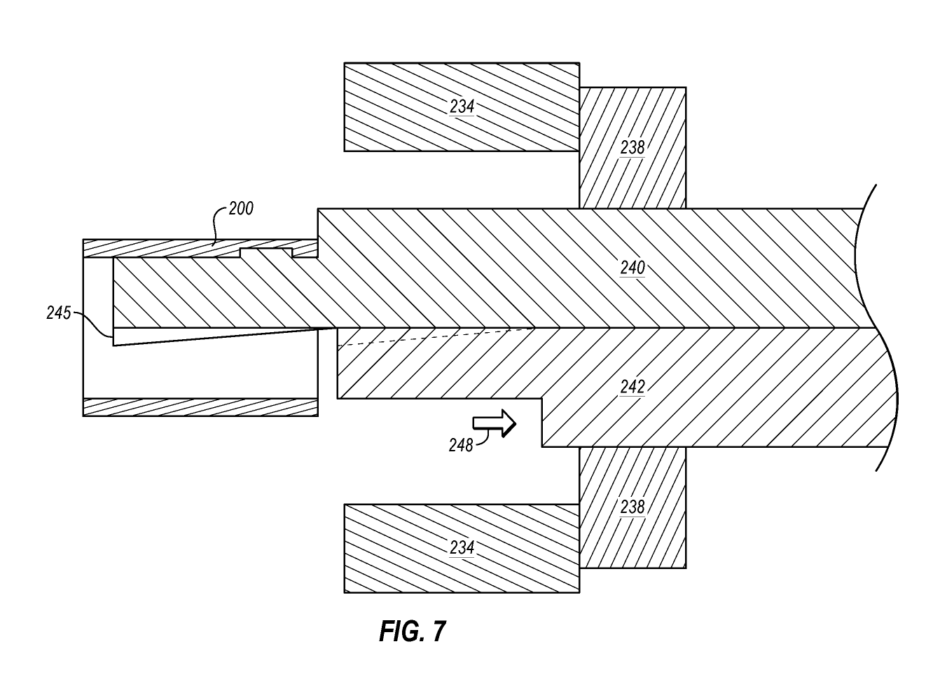

FIG. 8 illustrates one or more removal arms 250 holding the body 200 and moving the body 200 in a lateral direction and/or a longitudinal direction. Moving the body 200 in a lateral direction may lift the body 200 from the first core insert 240 and disengage the recess 206 from the protrusion 241. After disengaging the recess 206 and the protrusion 241, the body 200 may be free to move in the longitudinal direction relative to the first core insert 240 and be released from the mold.

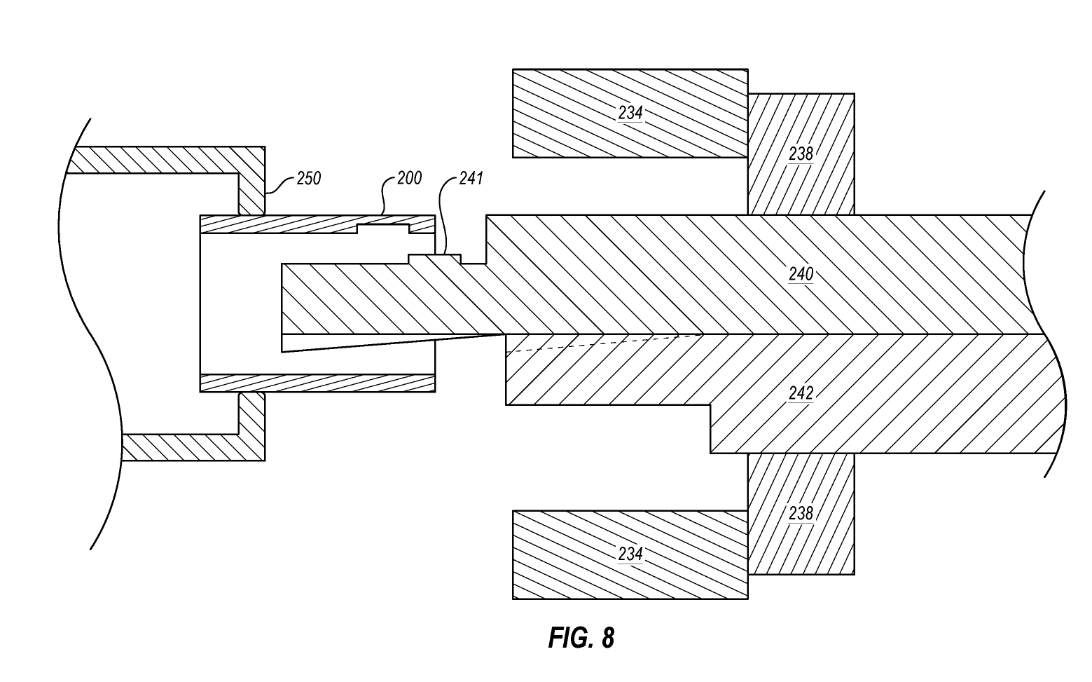

According to some embodiments of the process illustrated and described herein, a body with a recess in an inner surface may be injection molded and released from the mold. The embodiments of the process described herein may provide sufficient clearance around the body after molding to accommodate different embodiments and/or geometries of recesses. For example, FIG. 9 is a side cross-sectional view of another embodiment of a body 300 with a recess 306.

In some embodiments, the recess 306 may have a lower face 314 and an upper face 316 that are non-perpendicular to the longitudinal axis 309. For example, the lower face 314 and/or the upper face 316 may be oriented at an angle to the longitudinal axis 309 in a range having an upper value, a lower value, or upper and lower values including any of 15°, 20°, 25°, 30°, 35°, 40°, 45°, 50°, 55°, 60°, 65°, 70°, 75°, 80°, 85°, 90°, or any values therebetween in either longitudinal direction (e.g., 80° and 100° are both 80° from the longitudinal axis 309). For example, the lower face 314 and/or the upper face 316 may be oriented at an angle to the longitudinal axis 309 greater than 15°. In other examples, the lower face 314 and/or the upper face 316 may be oriented at an angle to the longitudinal axis 309 less than 90°. In yet other examples, the lower face 314 and/or the upper face 316 may be oriented at an angle to the longitudinal axis 309 less than 85°. In further examples, the lower face 314 and/or the upper face 316 may be oriented at an angle to the longitudinal axis 309 less than 80°.

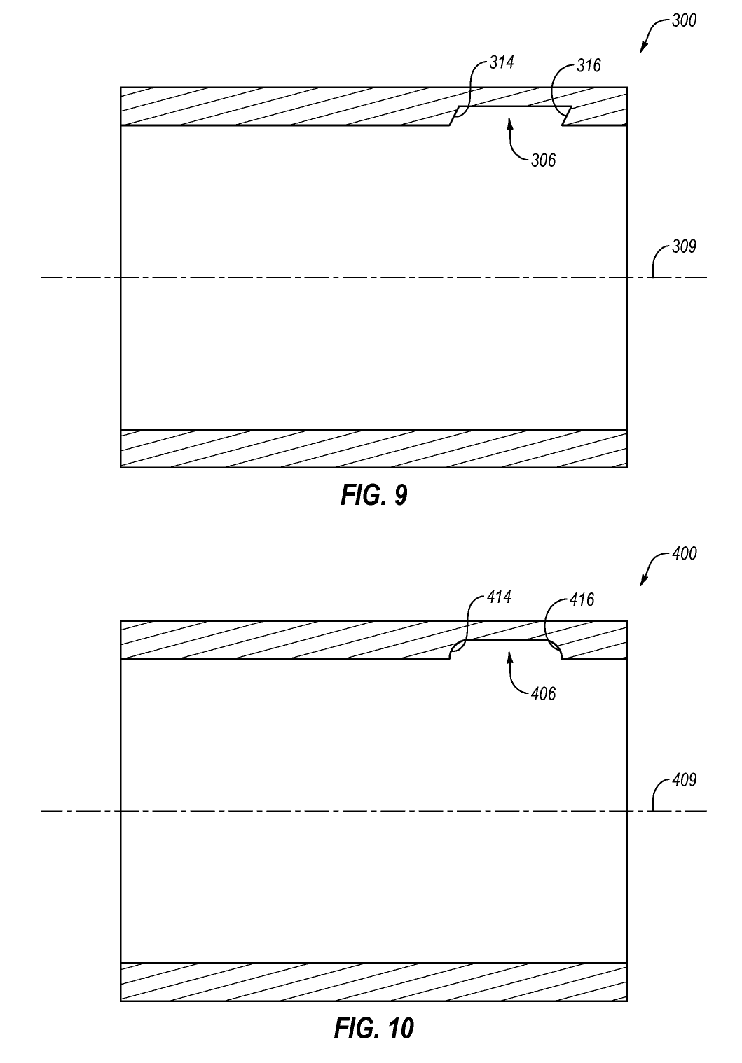

In other embodiments, such as that illustrated in FIG. 10, a body 400 may have a recess 406 that is at least partially curved in the longitudinal direction. For example, a lower face 414 and/or upper face 416 of the recess 406 may be curved along the full depth of the recess 406. In other examples, the lower face 414 and/or upper face 416 may be curved along less than the full depth, such as a curved corner between straight portions.

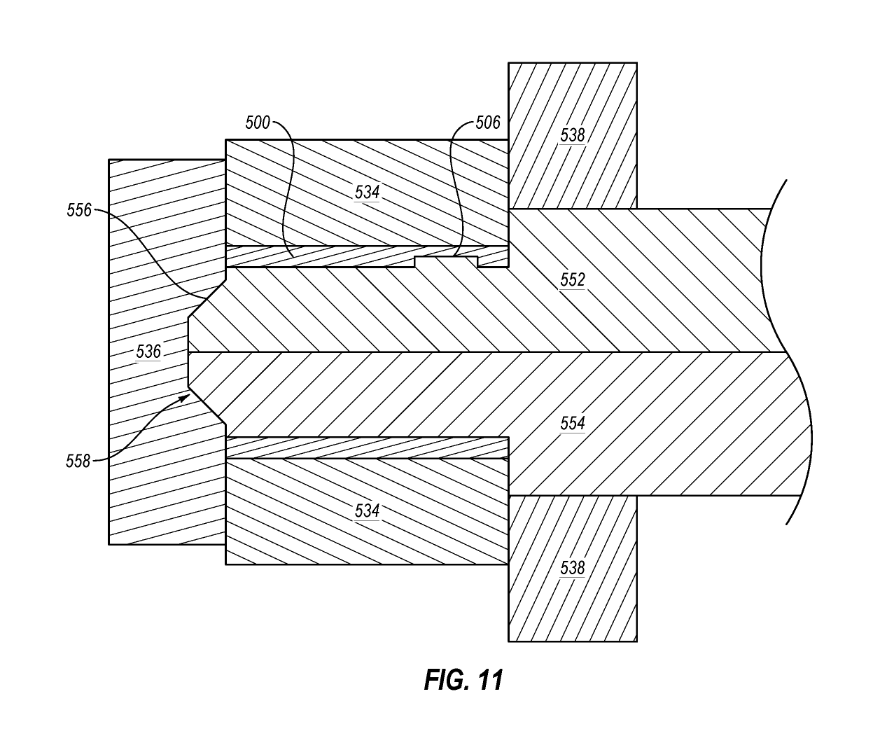

Embodiments of bodies according to the present disclosure may be injection molded according to the embodiments of a mold and process illustrated and described in relation to FIG. 3A through FIG. 8, or by other embodiments of a mold with a mandrel having a protrusion. FIG. 11 illustrates another embodiment of a mold having a plurality of components including first straight core insert 552 and second straight core insert 554 with a longitudinal interface. As described in relation to FIG. 3B and FIG. 7, in some embodiments, the first core insert and second core insert may have one or more engagement features to align the first core insert and second core insert and limit relative movement thereof. In other embodiments, the mold may include a first straight core insert 552 and a second straight core insert 554 that are aligned and compressed by another component of the mold during molding of a body 500 and recess 506. For example, the cavity 536 may having one or more angled faces 556 that engage with an angled extension 558 of each of the first straight core insert 552 and the second straight core insert 554. The contact between the one or more angle faces 556 against the angled extensions 558 may compress and align the first straight core insert 552 and the second straight core insert 554 when the mold is assembled to limit movement of the mold components during injection of the fluid. In other embodiments, one or more of the core 538 or sliders 534 may align and/or compress the first straight core insert 552 and the second straight core insert 554.

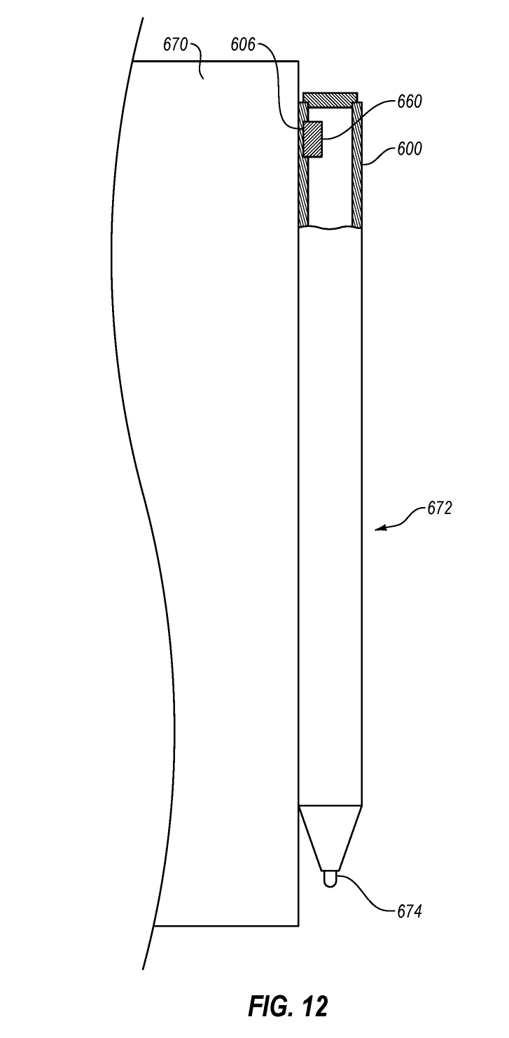

Injection molding of a small geometry body having a recess in the inner surface may allow for the assembly of electronic devices with improved performance or improved interaction with other devices. FIG. 12 illustrates a side partial cross-section of a stylus 672 adjacent a computing device 670. In some embodiments, the stylus 672 may include a body 600 with a recess 606. The recess 606 may allow for the longitudinal and/or rotational fixation of one or more electronic components 660 in the stylus 672 by positioning at least a portion of the electronic component 660 in the recess 606. In other embodiments, the recess 606 may allow the positioning of one or more electronic components 660 in the recess 606 to be closer to an outer surface of the stylus 672 or other electronic device, and hence closer to another object or device, such as the computing device 670.

In some embodiments, the electronic component 660 may include a magnet to magnetically attach the stylus 672 or other electronic device to any magnetic object or surface. For example, the force created by a magnetic field is exponentially related to the distance from the magnet, meaning the attachment force is exponentially increased by moving the magnet closer to the outer surface of the stylus 672 or other electronic device.

In other embodiments, the electronic component 660 may include a charging coil to inductively charge a battery via exposure of the charging coil to a magnetic field. Again, the force and hence, current, created by a magnetic field is exponentially related to the distance from the magnet, meaning the charging current is exponentially increased by moving the charging coil closer to the outer surface of the stylus 672 or other electronic device.

In yet other embodiments, the electronic component may include a wireless transceiver, capacitive sensor, or other communications component that allows for a user or other electronic device (such as computing device 670) to interact with and/or communicate with the stylus 672 or other electronic device. For example, a stylus 672 may have a tip 674 with a pressure sensor. The capacitive sensor may allow for the activation or deactivation of the pressure sensor in the tip 674 without introducing a physical button to the outer surface of the stylus 672.

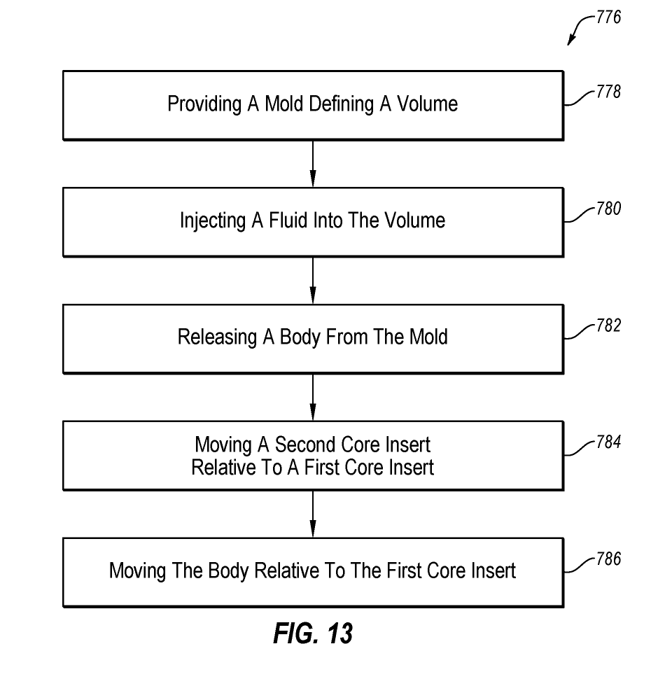

FIG. 13 is a flowchart illustrating an embodiment of a method 776 of manufacturing one or more embodiments of a body according to the present disclosure using an injection molding process similar to that described herein. The method 776 may include providing a mold defining a volume at 778. The volume may substantially define the shape of a body to be formed. The mold may define the outer surface and inner surface of the volume, while the mandrel defining the inner surface of the volume may include a protrusion.

The method 776 may include injecting a fluid into the volume at 780, which may subsequently cure and/or harden into a body material. In some embodiments, the body material may include polycarbonates and/or any range of thermoplastic resins. The body material may be a rigid material.

After the body solidifies in the mold, the body may be released from the mold at 782. In some embodiments, releasing the body from the mold may include removing the mold from the mandrel. To remove the mold from the mandrel, a first core insert and second core insert that are part of the mandrel may be moved relative to one another in a longitudinal direction at 784, such as described in relation to FIG. 6 and FIG. 7. The method 776 may further include moving the body relative to the first core insert in a transverse direction at 786 to disengage a recess of the body from the protrusion of the first core insert, such as described in relation to FIG. 8.

In at least some embodiments, a device according to the present disclosure and a method according to the present disclosure may allow for less expensive, faster manufacturing of smaller geometry parts than conventional devices and manufacturing methods. In at least one embodiment, injection molding according to the present disclosure may allow the manufacture of smaller and stronger pieces than conventional methods.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A device, the device comprising:
a body, the body including an outer surface and an inner surface defining a bore within the body, the inner surface defining a maximum inner dimension of the bore no more than 10 millimeters, the bore having a longitudinal axis therethrough;
a plurality of parting lines on the inner surface of the body; and
a recess in the inner surface of the body, the recess being a housed recess and having a depth in a lateral direction perpendicular to the longitudinal axis of the bore.

2. The device of claim 1, the recess having an upper face at a first longitudinal end of the recess and a lower face at an opposing second longitudinal end of the recess, the upper face and lower face extending from the inner surface toward the outer surface.

3. The device of claim 1, wherein the body includes a body material having an elastic modulus greater than 30 Shore A.

4. The device of claim 1, the plurality of parting lines oriented at a wedge angle to the longitudinal axis.

5. The device of claim 4, the wedge angle being greater than 5°.

6. The device of claim 1, the body further including an upper surface at an upper longitudinal end of the bore, the upper surface being continuous from the inner surface to the outer surface.

7. The device of claim 1, the inner surface having a pair of parting lines oriented parallel to the longitudinal axis.

8. The device of claim 1, the body having a length, the body further having an inner aspect ratio of the length to the maximum inner dimension of less than 3.5.

9. The device of claim 1, the body further having a recess ratio of the depth of the recess to the maximum inner dimension, the recess ratio being between 0.01 and 0.3.

10. The device of claim 1, the body having a thickness between the inner surface and the outer surface, and the body further having a thickness ratio of the depth of the recess to the thickness of the body that is greater than 1:100.

11. An electronic device, the electronic device comprising:
a body, the body including an outer surface and an inner surface defining a bore within the body, the inner surface defining a maximum inner dimension of the bore no more than 10 millimeters, the bore having a longitudinal axis therethrough;
a recess in the inner surface of the body and having a depth in a lateral direction perpendicular to the longitudinal axis of the bore, the depth being at least 1% of the maximum inner dimension; and
an electronic component positioned at least partially in the recess.

12. The electronic device of claim 11, the electronic component being selected from a group including a wireless transceiver, a magnet, a capacitive sensor, and a recharge coil.

13. The electronic device of claim 11, wherein the body is part of a stylus body.

14. The electronic device of claim 11, wherein the electronic component is positioned within 1.0 millimeter of the outer surface.

15. A method of manufacturing a device, the method comprising:
providing a mold having a mandrel including a first core insert with a protrusion in a lateral direction and a second core insert, the mold defining a volume where the mandrel defines an inner surface of the volume with an inner diameter no more than 10 millimeters;
injecting a fluid into the volume to form a body having a recess in an inner surface of a bore, the recess corresponding to the protrusion; and
releasing the body from the mold, wherein releasing the body includes:
moving the second core insert in a longitudinal direction relative the first core insert and body, and
moving the body in the lateral direction relative to the first core insert and in a protrusion direction to disengage the body from the protrusion.

16. The method of claim 15, the mold having a plurality of sliders that define an outer surface of the volume, wherein releasing the body from the mold further includes moving the plurality of sliders in the lateral direction.

17. The method of claim 15, the first core insert and second core insert having complimentary engagement features, wherein moving the second core insert relative to the first core insert disengages the complimentary engagement features.

18. The method of claim 15, moving the second core insert in the longitudinal direction further including moving the second core insert longitudinally such that the body and the second core insert do not longitudinally overlap.

19. The method of claim 15, releasing the body from the mold further including leaving an angled parting line on an inner surface of the body.

20. The method of claim 15, moving the second core insert in a longitudinal direction relative the first core insert and body further including moving the first core insert in an opposite longitudinal direction.
